(19) United States
(12) Patent Application Publication
(10) Pub. No.: US 2010/0144450 A1
(43) Pub. Date: Jun. 10, 2010

(54) POWER TRANSMISSION

(76) Inventors: Kazuhiko Takai, Gunma (JP); Sueji Hirawatari, Tochigi (JP); Toshiki Fukasawa, Gunma (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/602,931

(22) PCT Filed: May 27, 2008
(86) PCT No.: PCT/JP2008/059730

§ 371 Date: Dec. 3, 2009

(30) Foreign Application Priority Data
Jun. 4, 2007 (JP) 2007-147904

(51) Int. Cl. F16D 9/04

(52) U.S. Cl. 464/32

(57) ABSTRACT

A power transmission device having a coupling portion of a driven body and a drive body constituted by combining a positive torque transmission member for transmitting torque in forward rotational direction but interrupting transmission of torque from the drive body by breaking itself when the drive load of the driven body exceeds a predetermined level, with a separate negative torque transmission member for transmitting torque in reverse rotational direction is further provided with a means for generating pretension in the positive torque transmission member in the pulling direction and simultaneously generating a pretension in the negative torque transmission member in the compressing direction after both torque transmission members are combined. A highly reliable power transmission device which can impart a desired pretension precisely and conveniently, and can interrupt torque properly by suppressing fatigue of material at the coupling portion can be provided.

### TECHNICAL FIELD OF THE INVENTION

The present invention relates to a power transmission, for example, to a power transmission suitable to transmit driving force from a vehicle engine to a device mounted in the vehicle (e.g. a compressor used in an air conditioning system for the vehicle).

### BACKGROUND ART OF THE INVENTION

As a conventional technology, a fracture-type torque limiter which has a member or a portion to be fractured when a transmission load over a predetermined value is provided between a member at the driving side and a member at the driven side. For example, in Patent document 1, a fracture-type torque limiter is disclosed wherein, when a compressor is abnormally stopped by a failure, etc., a coupling member which is provided between a pulley at the drive source side and a rotation transmission plate attached to a shaft of the compressor at the driven side is fractured. In the conventional fracture-type torque limiter, however, because fluctuation load due to torque fluctuation entirely acts on the part or the member to be fractured, fatigue phenomenon occurs at this portion, and therefore, it may be fractured at a torque lower than a target fracture torque.

For such a problem, the applicant of the present application previously proposed a power transmission (although it has not yet been published) in which a drive body and a driven body rotated in the same direction are coupled through a coupling portion, and by forming the coupling portion from members different from each other, the fatigue phenomenon of the part to be fractured, that has been a problem in the conventional technology, is decreased, and the target torque interruption can be securely achieved (Japanese Patent Application 2006-241277).

According to this previously proposed invention, the above-described the coupling portion is constituted by combination of a positive torque transmission member for transmitting torque in a forward rotational direction and interrupting transmission of torque by its own fracture when the drive load of the driven body exceeds a predetermined level and a negative torque transmission member capable of transmitting torque in a reverse rotational direction, and by providing pretensions to the above-described positive torque transmission member and the above-described negative torque transmission member in directions opposite to each other, namely, by providing a tensile preload and a compressive preload thereto, the tensile preload and the compressive preload can operate in directions opposite to each other when the amplitude of torque fluctuation is decreased, and the amplitude of torque fluctuation can be efficiently decreased. Therefore, by this previous proposal, the conventional problems can be solved, thereby realizing a power transmission having an excellent reliability.

Patent document 1: Japanese Utility Model 6-39105

### DISCLOSURE OF THE INVENTION

### Problems to be Solved by the Invention

However, rooms for further improvement are left even in the above-described previous proposal. Namely, in the previous proposal, if any dispersion occurs in the pretensions provided when the coupling portion is assembled, stable pretensions cannot be provided and the effect for decreasing fatigue phenomenon may not be obtained enough. Further, if the structure of the coupling portion becomes complicated in order to provide the pretensions more precisely, reduction of mass production property and cost up accompanying with increase of the number of parts may be caused. Therefore, as the structure of the coupling portion, matters are to be required, to be able to provide desirable pretensions more precisely and to be able to provide the pretensions easily, that seem to be contrary matters.

Accordingly, based on the above-described previous proposal having solved problems in the conventional power transmission as aforementioned, in order to satisfy the above-described requirements in the previous proposal, an object of the present invention is to provide a power transmission with a high reliability which has a coupling portion of a drive body and a driven body capable of providing desirable pretensions precisely and easily.

### Means for Solving the Problems

To achieve the above-described object, a power transmission according to the present invention in which a driven body and a drive body for driving the driven body are rotated in the same direction and are coupled through a coupling portion, torque of the drive body is transmitted to the driven body, transmission of torque from the drive body is interrupted when a drive load of the driven body exceeds a predetermined level, and the coupling portion is constituted by combining members different from each other of a positive torque transmission member for transmitting torque in a forward rotational direction and interrupting transmission of torque from the drive body by its own fracture when the drive load of the driven body exceeds the predetermined level and a negative torque transmission member capable of transmitting torque in a reverse rotational direction, is characterized in that a pretension generating means is provided for simultaneously generating pretensions in directions opposite to each other of a pretension in the positive torque transmission member in a tensile direction and a pretension in the negative torque transmission member in a compressive direction after the positive torque transmission member and the negative torque transmission member are combined.

Namely, the alternate load of the positive torque and the negative torque is not received by only one member, but the respective loads are received by the positive torque transmission member and the negative torque transmission member formed from members different from each other which are provided with characteristics different from each other, and first, by this structure, occurrence of fatigue phenomenon generating on only one member by the alternate load is suppressed, it becomes possible to avoid that a torque transmitting member is fractured by a torque much smaller than a target interruption torque value. In these positive torque transmission member and negative torque transmission member, pretensions in directions opposite to each other are intentionally generated by the pretension generating means. By operating the pretension generating means after combining the positive torque transmission member and the negative torque transmission member, it becomes possible to act loads in directions opposite to each other simultaneously on these both members by relationship of action/reaction, and therefore, the pretensions in directions opposite to each other are simultaneously generated efficiently and easily. Then, by operating the pretension generating means properly, these pretensions in directions opposite to each other are set at desirable pretensions precisely.

In this power transmission according to the present invention, the above-described pretension generating means may be constituted as means for deforming the negative torque transmission member plastically.

For example, it can be structured so that a through hole with an oval or slot shape is provided to the above-described negative torque transmission member, the negative torque transmission member is deformed plastically by applying a compression load to the negative torque transmission member in a minor axis direction of the through hole, and the pretensions in directions opposite to each other are provided to the negative torque transmission member and the positive torque transmission member, respectively, via the plastic deformation. In such a structure, by the plastic deformation of the negative torque transmission member due to application of the above-described compression load, the negative torque transmission member is liable to elongate in its longitudinal direction, and at the same time, the positive torque transmission member being in a condition of assembly together with the negative torque transmission member acts in a direction for suppressing this elongation of the negative torque transmission member, and therefore, a pretension in a compressive direction is generated in the negative torque transmission member in its longitudinal direction and a pretension in a tensile direction is generated in the positive torque transmission member, simultaneously. By properly setting the shape and size of the through hole and the compression load applied in the minor axis direction, the pretensions in directions opposite to each other can be set precisely at desirable pretensions.

Further, the above-described structure, wherein the pretension generating means is constituted as means for deforming the negative torque transmission member plastically, can also be structured so that the negative torque transmission member has a curved shape portion, the negative torque transmission member is deformed plastically by applying a load to the curved shape portion of the negative torque transmission member in a direction of decreasing a curvature of the curved shape portion, and the pretensions in directions opposite to each other are provided to the negative torque transmission member and the positive torque transmission member, respectively, via the plastic deformation. In such a structure, since the negative torque transmission member being in a condition of assembly together with the positive torque transmission member is in a condition suppressed with elongation and deformation in its longitudinal direction by the positive torque transmission member, by applying a load to the curved-shape portion in a direction of decreasing the curvature of the curved-shape portion, a compression load acts on the negative torque transmission member, which is suppressed with deformation, in its longitudinal direction, and a pretension in a compressive direction is generated therein. By properly setting the shape and size of the curved-shape portion and the compression load applied in the direction of decreasing the curvature, the pretensions in directions opposite to each other can be set precisely at desirable pretensions.

Further, in the power transmission according to the present invention, the above-described pretension generating means may be constituted as a structure having a compression load adjusting means for applying a compression load to the negative torque transmission member and capable of adjusting the compression load by it own rotation.

For example, it can be structured so that the compression load adjusting means comprises a cam member engaging with one end of the negative torque transmission member, and the pretensions in directions opposite to each other are provided to the negative torque transmission member and the positive torque transmission member, respectively, via rotation of the cam member. In such a structure, it becomes possible to act a compression load in the negative torque transmission member in its longitudinal direction by the rotation of the cam member (for example, a cam member having an oval shape), and at the same time, it becomes possible to act a tensile load in the positive torque transmission member being in a condition of assembly together with the negative torque transmission member by relationship of action/reaction, and therefore, the pretensions in directions opposite to each other can be generated in both members simultaneously, efficiently and easily. By properly setting the shape and size of the cam member and properly adjusting its rotation, the pretensions in directions opposite to each other can be set precisely at desirable pretensions.

Further, it may be structured so that the compression load adjusting means comprises a bolt provided so as to form a part of the positive torque transmission member, and the pretensions in directions opposite to each other are provided to the negative torque transmission member and the bolt (that is, the positive torque transmission member), respectively, via rotation of the bolt. In such a structure, it becomes possible to act a compression load in the negative torque transmission member being in a condition of assembly together with the bolt or a portion forming a part of the negative torque transmission member by the rotation of the bolt in its fastening direction, and at the same time, it becomes possible to act a tensile load in the bolt forming a part of the positive torque transmission member by relationship of action/reaction, and therefore, the pretensions in directions opposite to each other can be generated in both members simultaneously, efficiently and easily. By properly setting the shape and size of the bolt and properly adjusting its rotation, the pretensions in directions opposite to each other can be set precisely at desirable pretensions.

Furthermore, in the power transmission according to the present invention, it can also be structured so that the pretension generating means is constituted as a mechanism in which the negative torque transmission member is assembled at a condition rotatable around a center at its one end portion, an arc-like end surface capable of applying a tensile-direction load to the positive torque transmission member when the negative torque transmission member is rotated is formed at the other end of the negative torque transmission member, and by the rotation of the negative torque transmission member, the pretension in the tensile direction due to the tensile-direction load is generated in the positive torque transmission member and the pretension in the compressive direction as a reaction force is generated simultaneously in the negative torque transmission member, respectively. By such a structure, at the time of assembly, it becomes possible to provide desirable pretensions in directions opposite to each other merely by rotating the negative torque transmission member in a predetermined direction, and providing of the pretensions and the structure therefore can be simplified.

In this structure, for example, a structure can be employed wherein the above-described arc-like end surface of the negative torque transmission member is formed in a shape such that, when the negative torque transmission member is rotated, the arc-like end surface is engaged with while being contacted with an intermediate member (for example, a collar as shown in an example described later) which is provided at an end of the positive torque transmission member located at an opposite side to the side of the rotational center of the negative torque transmission member and can be moved integrally with the end of the positive torque transmission member in the tensile direction of the positive torque transmission member.

### EFFECT ACCORDING TO THE INVENTION

Thus, in the power transmission according to the present invention, even in case where there is a torque fluctuation in drive source or drive body side, for example, even if there is an engine fluctuation, its influence can be suppressed as little as possible, occurrence of fatigue of material in the coupling portion is suppressed, and the torque interruption can be performed properly at a target interruption torque value. Further, providing of the pretensions to the positive and negative torque transmission members in directions opposite to each other for performing this proper torque interruption more securely can be carried out precisely and easily.

### BRIEF EXPLANATION OF THE DRAWINGS

FIG. 1 is an elevational view of a power transmission according to Example 1 of the present invention.

FIG. 2 is a diagram of a torque transmission member sub-assembly in Example 1, FIG. 2(A) is an exploded diagram, FIG. 2(B) is a sectional view after assembly, FIG. 2(C) is a plan view before plastic deformation and FIG. 2(D) is a plan view after plastic deformation.

FIG. 3 is an elevational view of a power transmission according to Example 2 of the present invention.

FIG. 4 is a diagram of a torque transmission member sub-assembly in Example 2, FIG. 4(A) is an exploded diagram, FIG. 4(B) is a sectional view after assembly, FIG. 4(C) is a sectional view before plastic deformation and FIG. 4(D) is a sectional view after plastic deformation.

FIG. 5 is an elevational view of a power transmission according to Example 3 of the present invention.

FIG. 6 is a diagram of a torque transmission member sub-assembly in Example 3, FIG. 6(A) is an exploded diagram, FIG. 6(B) is a sectional view after assembly, FIG. 6(C) is a plan view before rotation of a cam member, FIG. 6(D) is a plan view after rotation of a cam member and FIG. 6(E) is a sectional view showing attachment of a pin or rivet.

FIG. 7 is an elevational view of a power transmission according to Example 4 of the present invention.

FIG. 8 is a diagram of a torque transmission member sub-assembly in Example 4, FIG. 8(A) is an exploded diagram and FIG. 8(B) is a plan view after assembly.

FIG. 9 is an elevational view of a power transmission according to Example 5 of the present invention.

FIG. 10 is a diagram of a torque transmission member sub-assembly in Example 5, FIG. 10(A) is a plan view, FIG. 10 (B) is a sectional view and FIG. 10(C) is a plan view showing rotation of a negative torque transmission member.

### EXPLANATION OF SYMBOLS

1, 21, 31, 41, 51: power transmission
2: pulley as drive body
3: hub as driven body
4: main shaft of compressor
5: nut
6, 22, 32, 42, 52: coupling portion
6a, 22a, 32a: torque transmission member sub-assembly before providing pretension
6b, 22b, 32b: torque transmission member sub-assembly after providing pretension
7a, 7b: pin or rivet
8: positive torque transmission member
9a, 9b: sleeve
10: collar
11, 23, 33, 53: negative torque transmission member
12: through hole
13: compression load
24: curved shape portion
25: load
34: cam member
35: hole for pin
43a, 43b: divided member
44: bolt
54: arc-like end surface
55: collar as intermediate member

### THE BEST MODE FOR CARRYING OUT THE INVENTION

Hereinafter, desirable embodiments of the present invention will be explained referring to figures.

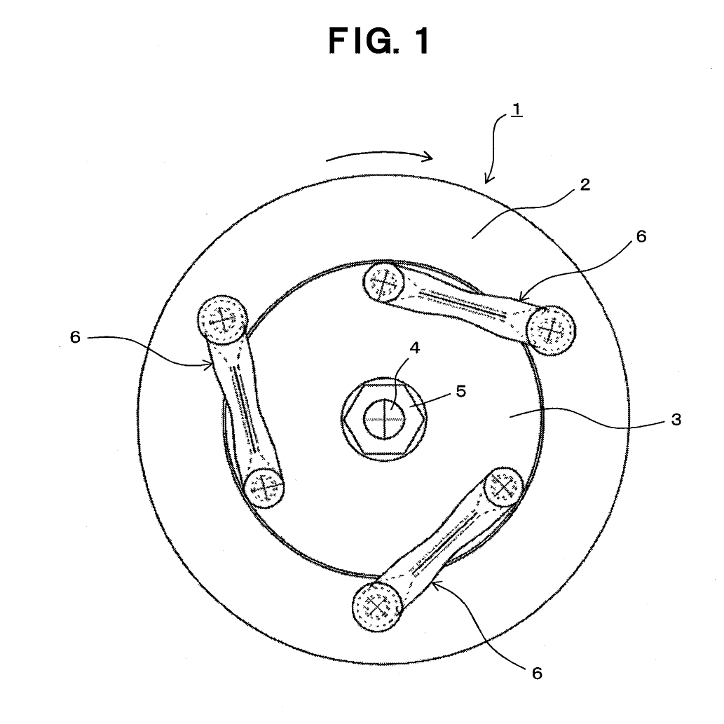

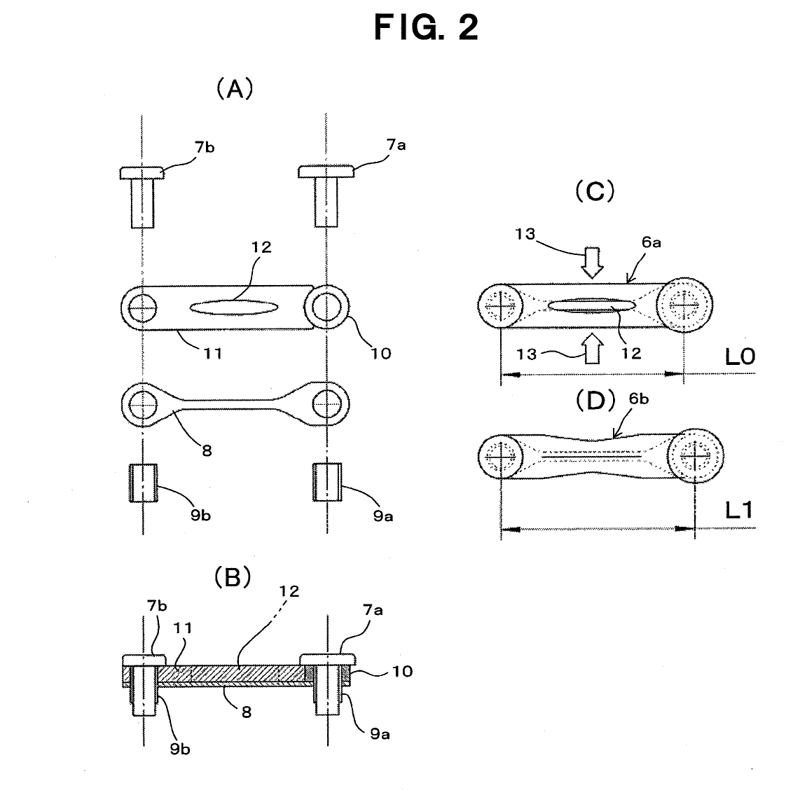

FIGS. 1 and 2 show a power transmission according to Example 1 of the present invention. In FIG. 1, numeral 1 indicates the entire power transmission, and power transmission 1 has pulley 2 as a drive body, for example, transmitted with a driving force from an engine, and hub 3 as a driven body, for example, connected and fixed to the end portion of main shaft 4 of a compressor via nut 5, which are rotated in the same direction (arrow direction in FIG. 1). These pulley 2 and hub 3 are coupled through coupling portion 6, the torque of pulley 2 provided as a drive body is transmitted to hub 3 provided as a driven body, and when the drive load of the driven body exceeds a predetermined level, the torque transmission is interrupted by fracture of a member (positive torque transmission member) constituting coupling portion 6. In this Example, a plurality of coupling portions 6, in particular, 3 sets of coupling portions 3, are disposed at an equal interval in the circumferential direction. In more detail, each coupling portion 6 is constituted by combination of a positive torque transmission member for transmitting a torque in a forward rotational direction (arrow direction in FIG. 1) and for interrupting the torque transmission from the drive body by its own fracture when the drive load of the driven body exceeds the predetermined level, and a negative torque transmission member capable of transmitting torque in a reverse rotational direction.

In this Example, each coupling portion 6 is formed by assembling the respective members integrally as a torque transmission member sub-assembly as depicted in FIG. 2. As depicted in FIGS. 2(A) and 2(B), each coupling portion 6 has a positive torque transmission member 8 extending between a pin or rivet 7a connected to one of pulley 2 and hub 3 and a pin or rivet 7b connected to the other, sleeves 9a, 9b fitted on the outer circumferences of pins or rivets 7a, 7b, a collar 10 fitted on the outer circumference of sleeve 9a, and a negative torque transmission member 11 whose one end is fitted and connected to sleeve 9b side and the other end of which is brought into contact with the outer circumferential surface of collar 10. A pretension generating means is provided to this negative torque transmission member 11 for, after positive torque transmission member 8 and negative torque transmission member 11 are combined, simultaneously generating pretensions in directions opposite to each other of a pretension in a tensile direction in the positive torque transmission member 8 and a pretension in a compressive direction in the negative torque transmission member 11.

In this Example, the pretension generating means is constituted as means for deforming negative torque transmission member 11 plastically, and in particular, it is structured such that a through hole 12 with an oval shape is provided to negative torque transmission member 11, negative torque transmission member 11 is deformed plastically by applying a compression load to negative torque transmission member 11 in a minor axis direction of this through hole 12 (a compression load 13 in a direction shown by arrow in FIG. 2(C) that is within a plasticity range of the material), and through the plastic deformation, a pretension in a compressive direction is provided to negative torque transmission member 11 and a pretension in a tensile direction is provided to positive torque transmission member 8, pretensions of which are directed in directions opposite to each other. Namely, in the condition of assembly as a torque transmission member sub-assembly, as shown in FIG. 2(C), compression load 13 is applied, and by this, through hole 12 is broken in its minor axis direction, and negative torque transmission member 11 is plastically deformed. At that time, although negative torque transmission member 11 is elongated in its longitudinal direction from a length L0 shown in FIG. 2(C) (distance between pin centers) to a length L1 shown in FIG. 2(D) (distance between pin centers), because the elongation of negative torque transmission member 11 is suppressed between sleeve 9b and collar 10, a compression load is applied to negative torque transmission member 11 in its longitudinal direction, thereby providing a pretension in a compressive direction. At the same time, a tensile load is applied in the longitudinal direction of positive torque transmission member 8, which is assembled together, between sleeves 9a, 9b from the relationship of action/reaction, thereby providing a pretension in a tensile direction. The pretension in a compressive direction provided in negative torque transmission member 11 and the pretension in a tensile direction provided in positive torque transmission member 8 are pretensions in directions opposite to each other, and both pretensions are balanced at conditions being provided. Symbol 6a in FIG. 2(C) indicates a torque transmission member sub-assembly before plastic deformation (before providing pretensions), and symbol 6b in FIG. 2(D) indicates a torque transmission member sub-assembly after plastic deformation (after providing pretensions).

In the power transmission 1 according to the above-described Example 1, pretensions in directions opposite to each other can be provided precisely and easily to positive torque transmission member 8 and negative torque transmission member 11 via plastic deformation of negative torque transmission member 11 due to application of compression load 13 in the minor axis direction of through hole 12. Thus, by providing desirable pretensions precisely, torque interruption can be performed properly at a target interruption torque value. Therefore, even in case where there is a torque fluctuation in drive source or drive body side, its influence can be suppressed as little as possible, occurrence of fatigue of material in the coupling portion is suppressed, and the torque interruption can be performed precisely at a target interruption torque value.

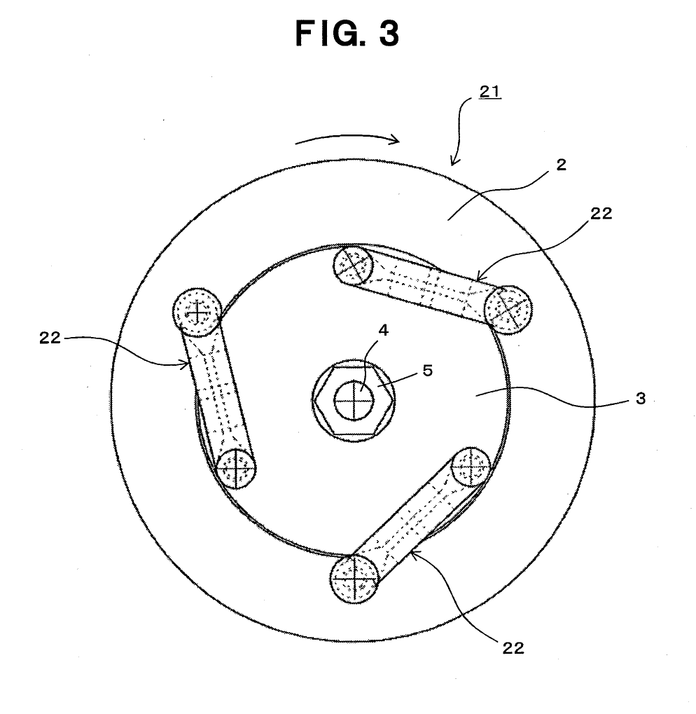

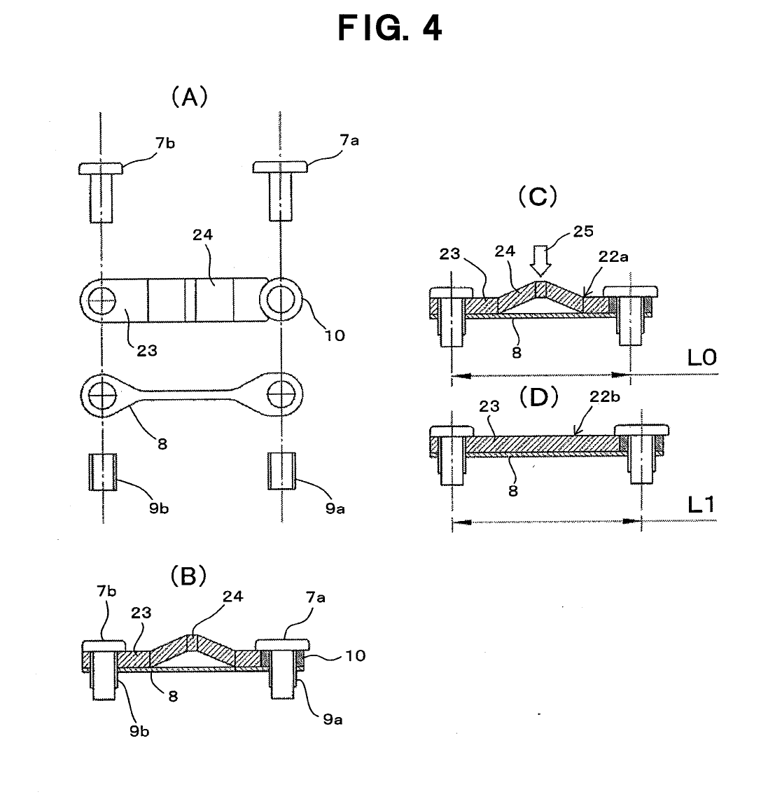

FIGS. 3 and 4 show a power transmission 21 according to Example 2 of the present invention. Explanation of the members in FIGS. 3 and 4 corresponding to those in FIGS. 1 and 2 is omitted by providing thereto the same symbols used in FIGS. 1 and 2. In this Example, each coupling portion 22 shown in FIG. 3 is formed by assembling the respective members integrally as a torque transmission member sub-assembly as depicted in FIG. 4. A pretension generating means defined in the present invention is provided to negative torque transmission member 23 in this torque transmission member sub-assembly, in this Example, the pretension generating means is constituted as means for deforming negative torque transmission member 23 plastically, and in particular, it is structured such that negative torque transmission member 23 has a curved shape portion 24, negative torque transmission member 23 is deformed plastically by applying a load to the curved shape portion 24 in a direction of decreasing a curvature of the curved shape portion 24 (load 25 by arrow in FIG. 4(C)), and through this plastic deformation, pretensions in directions opposite to each other are provided to negative torque transmission member 23 and positive torque transmission member 8, respectively. Namely, in the condition of assembly as the torque transmission member sub-assembly, as shown in FIG. 4(C), load 25 is applied, and by this, as shown in FIG. 4(D), curved shape portion 24 is plastically deformed in the longitudinal direction of negative torque transmission member 23. At that time, although negative torque transmission member 23 is elongated in its longitudinal direction from a length L0 shown in FIG. 4(C) (distance between pin centers) to a length L1 shown in FIG. 4(D) (distance between pin centers), because the elongation of negative torque transmission member 23 is suppressed between sleeve 9b and collar 10, a compression load is applied to negative torque transmission member 23 in its longitudinal direction, thereby providing a pretension in a compressive direction. At the same time, a tensile load is applied in the longitudinal direction of positive torque transmission member 8, which is assembled together, between sleeves 9a, 9b from the relationship of action/reaction, thereby providing a pretension in a tensile direction. The pretension in a compressive direction provided in negative torque transmission member 23 and the pretension in a tensile direction provided in positive torque transmission member 8 are pretensions in directions opposite to each other, and both pretensions are balanced at conditions being provided. Symbol 22a in FIG. 4(C) indicates a torque transmission member sub-assembly before plastic deformation (before providing pretensions), and symbol 22b in FIG. 4(D) indicates a torque transmission member sub-assembly after plastic deformation (after providing pretensions).

In the power transmission 21 according to the above-described Example 2, pretensions in directions opposite to each other can be provided precisely and easily to positive torque transmission member 8 and negative torque transmission member 23 via plastic deformation of negative torque transmission member 23 due to application of load 25 to curved shape portion 24 of negative torque transmission member 23. Thus, by providing desirable pretensions precisely, torque interruption can be performed properly at a target interruption torque value. Therefore, even in case where there is a torque fluctuation in drive source or drive body side, its influence can be suppressed as little as possible, occurrence of fatigue of material in the coupling portion is suppressed, and the torque interruption can be performed precisely at a target interruption torque value.

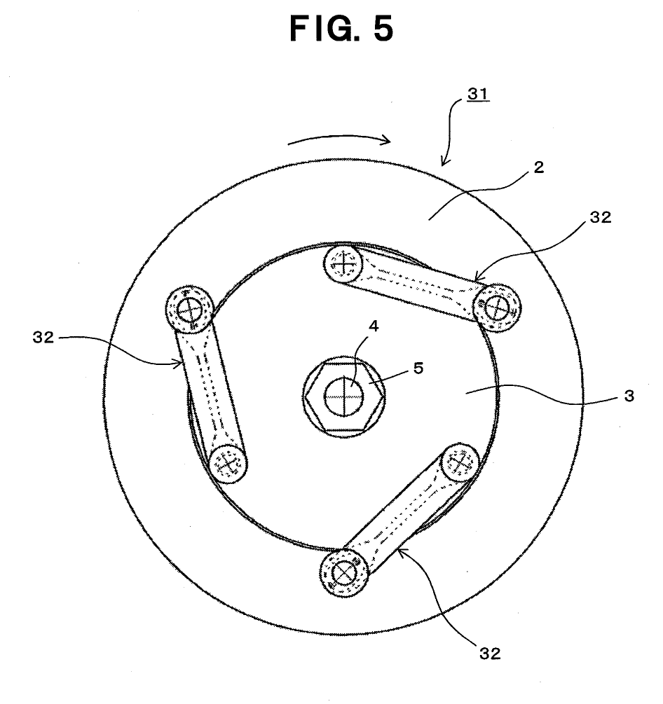

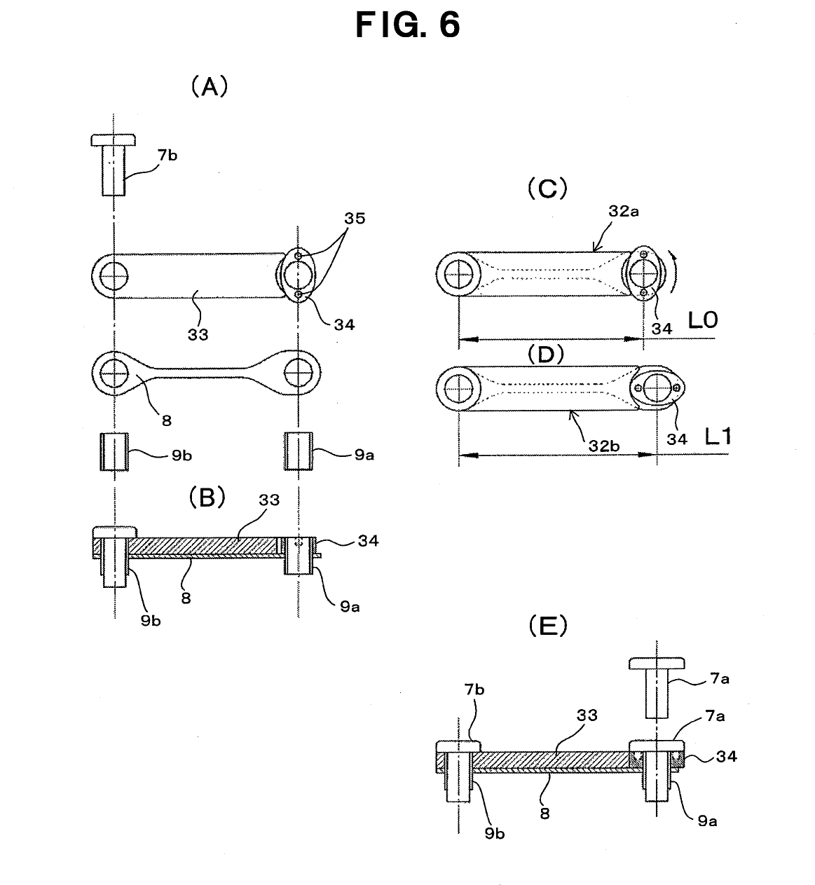

FIGS. 5 and 6 show a power transmission 31 according to Example 3 of the present invention. Explanation of the members in FIGS. 5 and 6 corresponding to those in FIGS. 1 and 2 is omitted by providing thereto the same symbols used in FIGS. 1 and 2. In this Example, each coupling portion 32 shown in FIG. 5 is formed by assembling the respective members integrally as a torque transmission member sub-assembly as depicted in FIG. 6. A pretension generating means defined in the present invention is provided to negative torque transmission member 33 in this torque transmission member sub-assembly, and in this Example, the pretension generating means is constituted as means having a compression load adjusting means for applying a compression load to negative torque transmission member 33 and capable of adjusting the compression load by it own rotation. In particular, in this Example, this compression load adjusting means comprises a cam member 34 with an oval shape of its outer circumferential surface which is fitted onto the outer circumference of sleeve 9a so as to engage with one end of negative torque transmission member 33, and pretensions in directions opposite to each other are provided to negative torque transmission member 33 and positive torque transmission member 8, respectively, via rotation of cam member 34. The rotation of cam member 34 can be easily carried out by inserting pins of a tool into a pair of holes for pins 35 provided on the upper surface of cam member 34 and rotating the tool by a predetermined angle. Namely, in the condition of assembly as the torque transmission member sub-assembly, as shown in FIG. 6(C), by rotating the oval-shape cam member 34 in the arrow direction, the outer circumferential surface in the major axis direction of the oval shape of cam member 34 comes into contact with the end surface of negative torque transmission member 33 and a compression load is applied to negative torque transmission member 33, and at the same time, a tensile load is applied in the longitudinal direction of positive torque transmission member 8, which is assembled together, between sleeves 9a, 9b from the relationship of action/reaction. At that time, when the length in the longitudinal direction of the torque transmission member sub-assembly before rotation of cam member 34 is referred to as L0 shown in FIG. 6(C) (distance between pin centers), it is elongated to a length L1 shown in FIG. 6(D) (distance between pin centers) after the rotation of cam member 34, but, a compression load acts on negative torque transmission member 33 in its longitudinal direction, by this a pretension in a compressive direction is provided, and at the same time, a tensile load is applied in the longitudinal direction of positive torque transmission member 8, thereby providing a pretension in a tensile direction. Pin or rivet 7a may be attached as shown in FIG. 6(E) after rotation of cam member 34 (after providing pretensions). The pretension in a compressive direction provided in negative torque transmission member 33 and the pretension in a tensile direction provided in positive torque transmission member 8 are pretensions in directions opposite to each other, and both pretensions are balanced at conditions being provided. Symbol 32a in FIG. 6(C) indicates a torque transmission member sub-assembly before rotation of cam member 34 (before providing pretensions), and symbol 32b in FIG. 6(D) indicates a torque transmission member sub-assembly after rotation of cam member 34 (after providing pretensions).

In the power transmission 31 according to the above-described Example 3, pretensions in directions opposite to each other can be provided precisely and easily to positive torque transmission member 8 and negative torque transmission member 23 by rotation of cam member 34. Thus, by providing desirable pretensions precisely, torque interruption can be performed properly at a target interruption torque value. Therefore, even in case where there is a torque fluctuation in drive source or drive body side, its influence can be suppressed as little as possible, occurrence of fatigue of material in the coupling portion is suppressed, and the torque interruption can be performed precisely at a target interruption torque value.

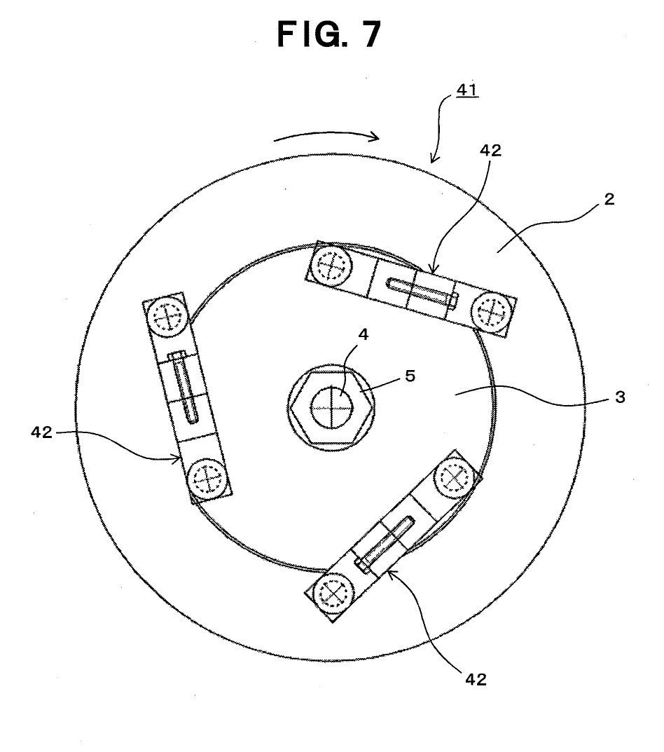

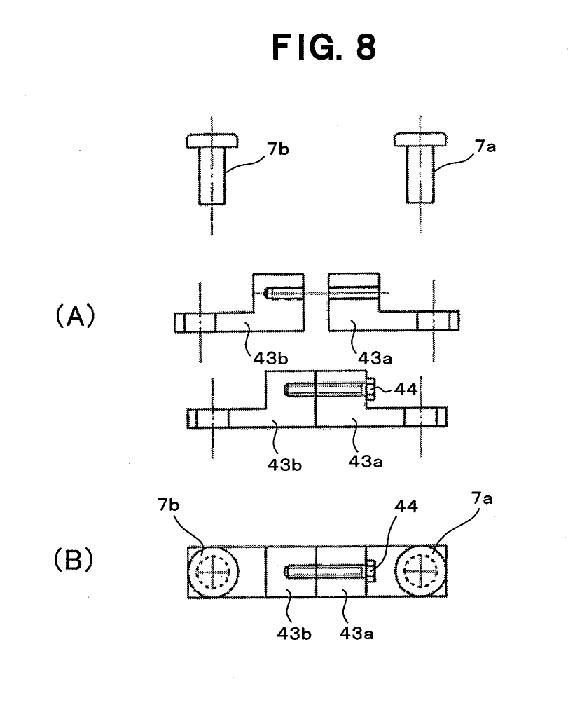

FIGS. 7 and 8 show a power transmission 41 according to Example 4 of the present invention. Explanation of the members in FIGS. 7 and 8 corresponding to those in FIGS. 1 and 2 is omitted by providing thereto the same symbols used in FIGS. 1 and 2. In this Example, each coupling portion 42 shown in FIG. 7 is formed by assembling the respective members integrally as a torque transmission member sub-assembly as depicted in FIGS. 8(A) and 8(B). In this Example, the torque transmission member sub-assembly has two divided members 43a, 43b connecting pins or rivets 7a, 7b, and a bolt 44 for fastening between these divided members 43a, 43b capable of securing them, bolt 44 and portions of divided members 43a, 43b connected to pins or rivets 7a, 7b are constituted as a positive torque transmission member, and portions of divided members 43a, 43b fastened by bolt 44 are constituted as a negative torque transmission member. By assembling bolt 44 and fastening it, a compression load is applied to the negative torque transmission member forming portions of divided members 43a, 43b, and by this, a pretension in a compressive direction is provided to those portions. At the same time, a pretension in a tensile direction is provided to bolt 44 forming a part of the positive torque transmission member. The pretension in a compressive direction provided in the negative torque transmission member forming portions and the pretension in a tensile direction provided in the positive torque transmission member forming portion are pretensions in directions opposite to each other, and both pretensions are balanced at conditions being provided.

In the power transmission 41 according to the above-described Example 4, pretensions in directions opposite to each other can be provided precisely and easily to the positive torque transmission member forming portion and the negative torque transmission member forming portions by rotation of bolt 44. Thus, by providing desirable pretensions precisely, torque interruption can be performed properly at a target interruption torque value. Therefore, even in case where there is a torque fluctuation in drive source or drive body side, its influence can be suppressed as little as possible, occurrence of fatigue of material in the coupling portion is suppressed, and the torque interruption can be performed precisely at a target interruption torque value.

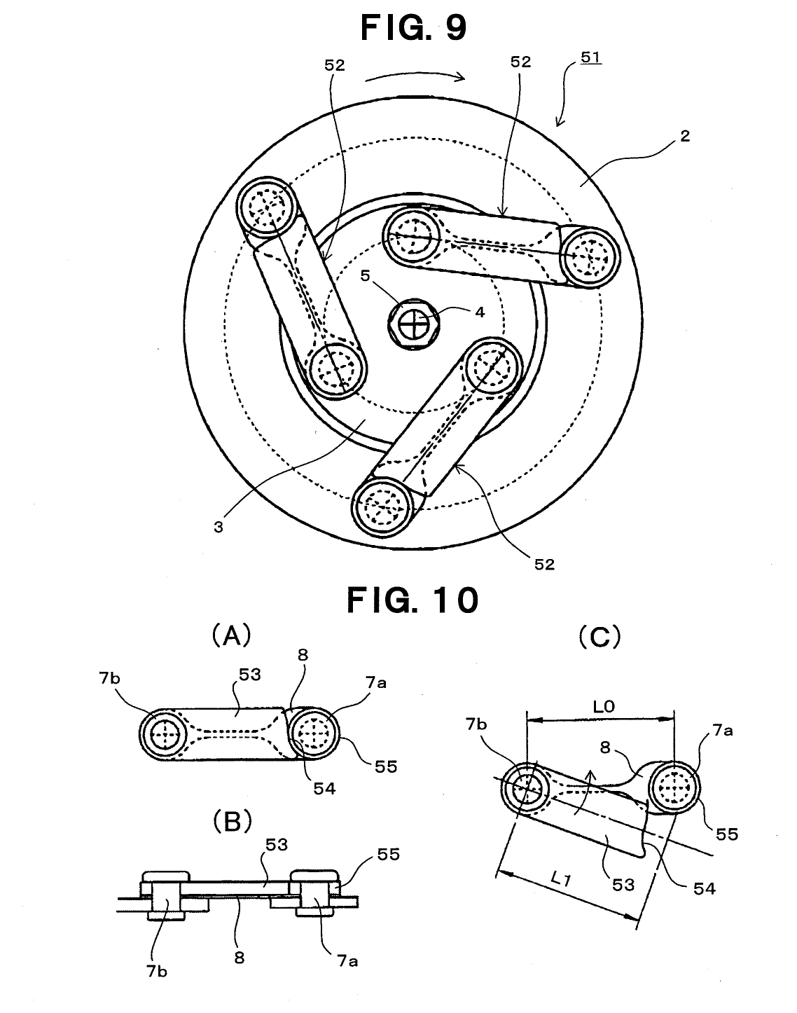

FIGS. 9 and 10 show a power transmission 51 according to Example 5 of the present invention. Explanation of the members in FIGS. 9 and 10 corresponding to those in FIGS. 1 and 2 is omitted by providing thereto the same symbols used in FIGS. 1 and 2. In this Example, each coupling portion 52 shown in FIG. 9 is formed by assembling the respective members integrally as a torque transmission member sub-assembly as depicted in FIG. 10. A pretension generating means defined in the present invention is provided to negative torque transmission member 53 in this torque transmission member sub-assembly, and in this Example, the pretension generating means is constituted as a mechanism in which negative torque transmission member 53 is assembled at a condition rotatable around a center at its one end portion (at the end of pin or rivet 7b side), an arc-like end surface 54 capable of applying a tensile-direction load to positive torque transmission member 8 when negative torque transmission member 53 is rotated is formed at the other end (at the end of pin or rivet 7a side) of negative torque transmission member 53, and by the rotation of negative torque transmission member 53, a pretension in a tensile direction due to the tensile-direction load is generated in positive torque transmission member 8 and a pretension in a compressive direction as a reaction force is generated simultaneously in negative torque transmission member 53, respectively.

More concretely, arc-like end surface 54 is formed in an arc shape having a center different from that for rotation of negative torque transmission member 53, and the end surface of negative torque transmission member 53 formed with this arc-like end surface 54 is formed as an inclined surface as a whole. A collar 55 as an intermediate member capable of being moved integrally with the end of positive torque transmission member 8 is fitted onto the outer circumference of pin or rivet 7a, at an end of positive torque transmission member 8 located at an opposite side to the side of the rotational center of negative torque transmission member 53 (at an end of pin or rivet 7a side). When negative torque transmission member 53 is rotated in the arrow direction shown in FIG. 10(C), while the above-described arc-like end surface 54 is brought into contact with the outer circumferential surface of collar 55, negative torque transmission member 53 is rotated up to a position engaged with collar 55 shown in FIGS. 10(A) and 10(B), and when arc-like end surface 54 comes to a position along the outer circumferential surface of collar 55 (a position just fitted to the outer circumferential surface), the rotation is stopped. At that time, before the end surface of negative torque transmission member 53 comes into contact with collar 55, the distance between pin centers of positive torque transmission member 8 (L0) corresponds to a distance at a condition where no load is applied to positive torque transmission member 8, but, when the end surface of negative torque transmission member 53 begins to come into contact with collar 55, arc-like end surface 54 pushes collar 55 in the axial direction of positive torque transmission member 8, and simultaneously a pretension in a tensile direction due to a tensile-direction load is generated in positive torque transmission member 8 and a pretension in a compressive direction as a reaction force is generated in negative torque transmission member 53, respectively. Then, when negative torque transmission member 53 is rotated up to a position where arc-like end surface 54 is fitted to the outer circumferential surface of collar 55, the above-described distance between pin centers of positive torque transmission member 8 (L0) is extended to L1, and predetermined pretensions in directions opposite to each other are provided to positive torque transmission member 8 and negative torque transmission member 53. Thus, it becomes possible to provide desirable pretensions precisely even by a very simple structure, thereby performing torque interruption properly at a target interruption torque value. Therefore, even in case where there is a torque fluctuation in drive source or drive body side, its influence can be suppressed as little as possible, occurrence of fatigue of material in the coupling portion is suppressed, and the torque interruption can be performed precisely at a target interruption torque value.

Where, in the above-described structure, as the side provided with arc-like end surface 54, any of drive body side and driven body side can be employed. Further, as the method for assembling positive torque transmission member 8 and negative torque transmission member 53, a method due to bolt fastening may be employed instead of pin or rivet.

### INDUSTRIAL APPLICATIONS OF THE INVENTION

The structure of the power transmission according to the present invention can be applied to any power transmission in which torque interruption is performed by fracture of a coupling member between a rotational drive body and a driven body, in particular, it is suitable to a case where an vehicle engine is employed as a drive source, for example, a case of transmitting a power to a compressor used in an air conditioning system for vehicles.

1. A power transmission in which a driven body and a drive body for driving said driven body are rotated in the same direction and are coupled through a coupling portion, torque of said drive body is transmitted to said driven body, transmission of torque from said drive body is interrupted when a drive load of said driven body exceeds a predetermined level, and said coupling portion is constituted by combining members different from each other of a positive torque transmission member for transmitting torque in a forward rotational direction and interrupting transmission of torque from said drive body by its own fracture when said drive load of said driven body exceeds said predetermined level and a negative torque transmission member capable of transmitting torque in a reverse rotational direction, characterized in that a pretension generating means is provided for simultaneously generating pretensions in directions opposite to each other of a pretension in said positive torque transmission member in a tensile direction and a pretension in said negative torque transmission member in a compressive direction after said positive torque transmission member and said negative torque transmission member are combined.

2. The power transmission according to claim 1, wherein said pretension generating means is constituted as means for deforming said negative torque transmission member plastically.

3. The power transmission according to claim 2, wherein a through hole with an oval or slot shape is provided to said negative torque transmission member, said negative torque transmission member is deformed plastically by applying a compression load to said negative torque transmission member in a minor axis direction of said through hole, and said pretensions in directions opposite to each other are provided to said negative torque transmission member and said positive torque transmission member, respectively, via said plastic deformation.

4. The power transmission according to claim 2, wherein said negative torque transmission member has a curved shape portion, said negative torque transmission member is deformed plastically by applying a load to said curved shape portion of said negative torque transmission member in a direction of decreasing a curvature of said curved shape portion, and said pretensions in directions opposite to each other are provided to said negative torque transmission member and said positive torque transmission member, respectively, via said plastic deformation.

5. The power transmission according to claim 1, wherein said pretension generating means has a compression load adjusting means for applying a compression load to said negative torque transmission member and capable of adjusting said compression load by it own rotation.

6. The power transmission according to claim 5, wherein said compression load adjusting means comprises a cam member engaging with one end of said negative torque transmission member, and said pretensions in directions opposite to each other are provided to said negative torque transmission member and said positive torque transmission member, respectively, via rotation of said cam member.

7. The power transmission according to claim 5, wherein said compression load adjusting means comprises a bolt provided so as to form a part of said positive torque transmission member, and said pretensions in directions opposite to each other are provided to said negative torque transmission member and said bolt, respectively, via rotation of said bolt.

8. The power transmission according to claim 1, wherein said pretension generating means is constituted as a mechanism in which said negative torque transmission member is assembled at a condition rotatable around a center at its one end portion, an arc-like end surface capable of applying a tensile-direction load to said positive torque transmission member when said negative torque transmission member is rotated is formed at the other end of said negative torque transmission member, and by said rotation of said negative torque transmission member, said pretension in said tensile direction due to said tensile-direction load is generated in said positive torque transmission member and said pretension in said compressive direction as a reaction force is generated simultaneously in said negative torque transmission member, respectively.

9. The power transmission according to claim 8, wherein said arc-like end surface of said negative torque transmission member is formed in a shape so that, when said negative torque transmission member is rotated, said arc-like end surface is engaged with while being contacted with an intermediate member which is provided at an end of said positive torque transmission member located at an opposite side to the side of said rotational center of said negative torque transmission member and can be moved integrally with said end of said positive torque transmission member in said tensile direction of said positive torque transmission member.
